(19) United States
(12) Patent Application Publication
(10) Pub. No.: US 2007/0273897 A1
(43) Pub. Date: Nov. 29, 2007

(54) Print systems and methods

(75) Inventor: Devid Wei, Taipei (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/441,624

(22) Filed: May 26, 2006

(51) Int. Cl. G06K 15/02

(52) U.S. Cl. 358/1.2

(57) ABSTRACT

Print systems and methods that repeatedly print a file on an output medium. The system comprises a user interface, a driver and a printer. The user interface receives a setup option comprising a column number, a row number and a copy number. The driver calculates a reduction/magnification ratio according to the column number and the row number, and calculates a deviation position for each file to be repeatedly printed on the output medium. The driver transmits at least one command corresponding to the file having the properties of the reduction/magnification ratio and the deviation position. The printer repeatedly prints the file on the output medium according to the command.

### BACKGROUND OF THE INVENTION

1. Field of the Invention

The disclosure relates generally to print systems and methods, and, more particularly to print systems and methods that repeatedly print a file on an output medium.

2. Description of the Related Art

With the population of computer systems, users can utilize the computer systems and related peripheral devices, such as digital cameras and printers to perform various applications. For example, users can control a computer system to print out their documents or figures via a printer.

Most printer drivers provide a function for printing a document with several pages on a single output medium. Users can select a setup option of 2, 4, 6, 9 or 16 from an interface provided by the printer driver, and 2, 4, 6, 9 or 16 pages of a document are then printed out on a single output medium accordingly.

In some cases, users need a request for repeatedly printing a file on an output medium, such as a request for reduce a photo and repeatedly printing the photo on a page. However, no such function is provided by conventional printer drivers. Users have to pay additional cost to purchase related software and applications, or manually configure image processing software to reduce the photo and repeatedly copy the photo to generate a new image file, and print the new image file via the printer. For users, the conventional practice is expensive and time inefficient.

### BRIEF SUMMARY OF THE INVENTION

Print systems and methods are provided.

An embodiment of a print system for repeatedly printing a file on an output medium comprises a user interface, a driver and a printer. The user interface receives a setup option comprising a column number, a row number and a copy number. The driver calculates a reduction/magnification ratio according to the column number and the row number, and calculates a deviation position for each file to be repeatedly printed on the output medium. The driver transmits at least one command corresponding to the file having the properties of the reduction/magnification ratio and the deviation position. The printer repeatedly prints the file on the output medium according to the command.

In an embodiment of a print method for repeatedly printing a file on an output medium, a setup option comprising a column number, a row number and a copy number is first received. A reduction/magnification ratio is calculated according to the column number and the row number by a driver. A deviation position for each file to be repeatedly printed on the output medium is calculated according to the reduction/magnification ratio by the driver. The driver transmits at least one command corresponding to the file having the properties of the reduction/magnification ratio and the deviation position. The command is received by a printer, and the printer repeatedly prints the file on the output medium according to the command.

Print systems and methods may take the form of program code embodied in a tangible media. When the program code is loaded into and executed by a machine, the machine becomes an apparatus for practicing the disclosed method.

### BRIEF DESCRIPTION OF THE DRAWINGS

The file of this patent contains at least one drawing executed in color. Copies of this patent with color drawing(s) will be provided by the Office upon request and payment of the necessary fee.

The invention will become more fully understood by referring to the following detailed description with reference to the accompanying drawings, wherein:

FIG. 1 is a schematic diagram illustrating an embodiment of a print system;

FIG. 2 is a flowchart showing an embodiment of a print method;

FIGS. 3A and 3B are schematic diagrams illustrating embodiments of user interfaces;

FIG. 4 is a schematic diagram illustrating a print out example.

### DETAILED DESCRIPTION OF THE INVENTION

Print systems and methods are provided.

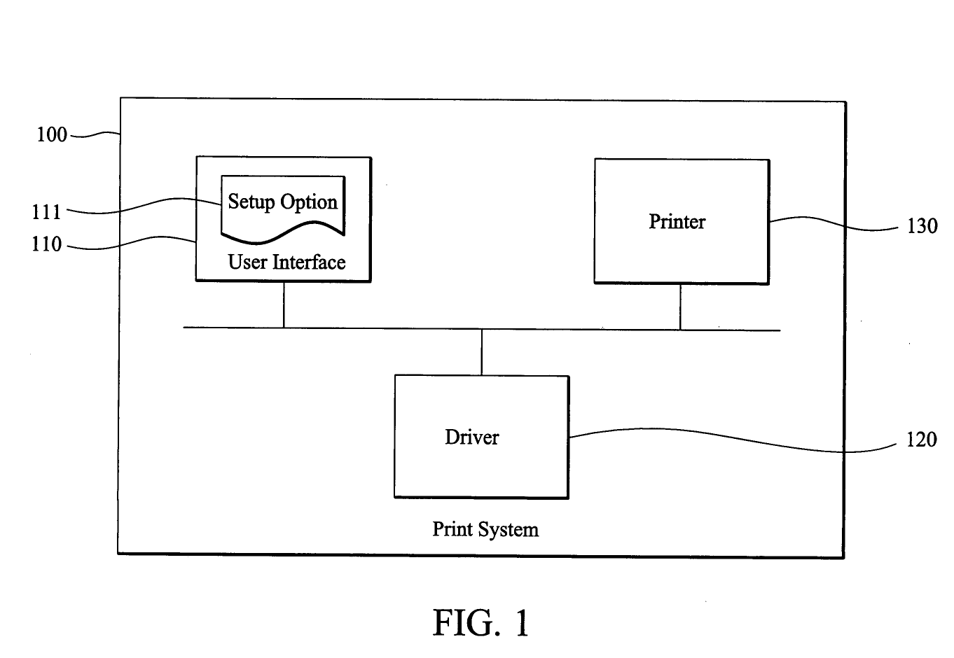

FIG. 1 is a schematic diagram illustrating an embodiment of a print system.

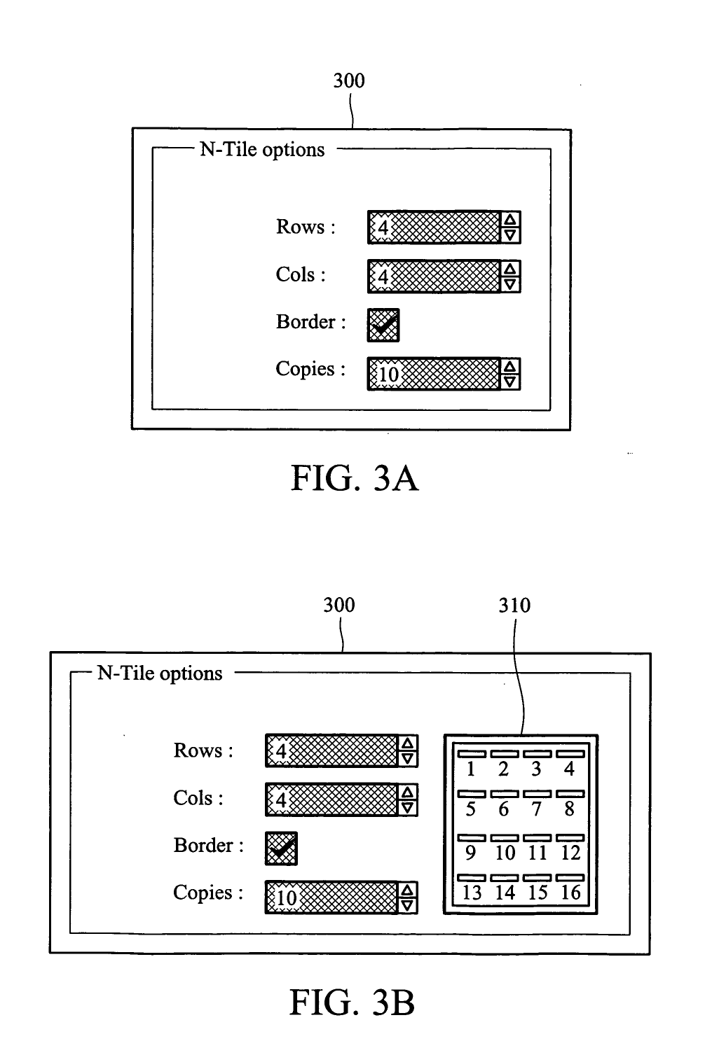

The print system 100 comprises a user interface 110, a driver 120, and a printer 130. FIGS. 3A and 3B illustrate embodiments of the user interface. As shown in FIGS. 3A and 3B, users can set the setup option for repeatedly printing via the user interface 300. The setup option comprises a column number “Cols”, a row number “Rows”, a border option “Border” and a copy number “Copies”. The column number represents the columns to be repeatedly printed in one output medium, and the range thereto is from 1 to 8. The row number represents the rows to be repeatedly printed in one output medium, and the range thereto is from 1 to 8. The border option determines whether to print borders on the files printed on the output medium. The copy number represents the number of a file to be repeatedly printed. It is noted that the difference between FIGS. 3A and 3B is the preview pages can be shown in the user interface 300 in FIG. 3B, and the preview pages can be displayed in block 310. Operation comprises first opening a specific file, selecting a print option from a print menu, and selecting an icon of the driver 120 corresponding to the printer 130. Then, if the attribute option is selected, the user interface 300 appears for related settings. After the setup option is set, the user interface 300 transmits the setup option to the driver 120 for subsequent processing.

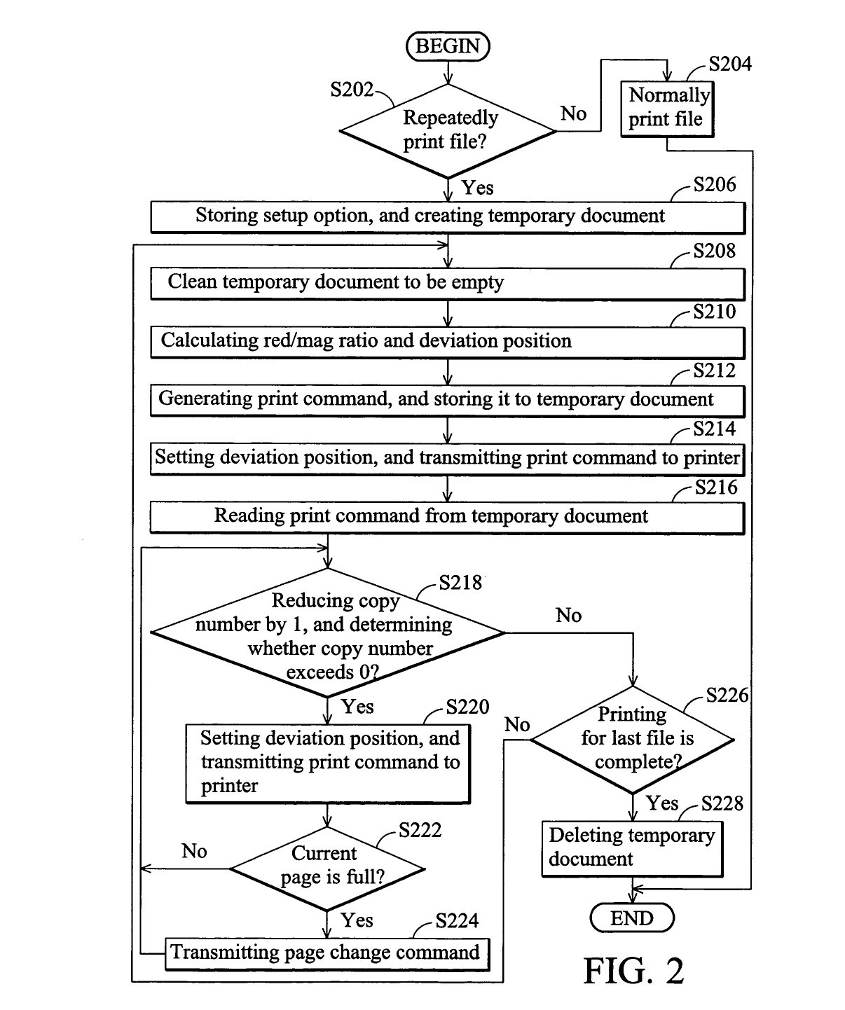

FIG. 2 is a flowchart showing an embodiment of a print method.

In step S202, the driver 120 determines whether the file is to be repeatedly printed. It is understood that the driver 120 receives the command from the user interface 300 via a graphics device interface (GDI), and determines whether to perform repeated printing. If the file is not to be repeatedly printed (“No” in step S202), in step S204, the file is printed normally. It is understood that at least one file must be opened or specified before setting the setup option via the user interface 300. If the file is to be repeatedly printed (“Yes” in step S202), in step S206, the driver 120 stores the setup option transmitted from the user interface 300, and creates a temporary document. The temporary document stores the print commands corresponding to the file.

In step S208, the temporary document is cleaned to be empty. In step S210, the driver 120 calculates a reduction/magnification ratio of the file according to the column number and the row number in the setup option, and calculates a deviation position for each file to be repeatedly printed on the output medium, such as paper. In step S212, the driver 120 generates a print command corresponding to the file according to the reduction/magnification ratio, and stores the print command in the temporary document. In step S214, the driver 120 sets the deviation position, and transmits the print command to the printer 130. Note that once the printer 130 receives the print command, the printer 130 prints the file according to the deviation position and the print command.

In step S216, the driver 120 reads the print command from the temporary document. In step S218, the copy number is reduced by one, and it is determined whether the copy number exceeds zero. If so (“Yes” in step S218), in step S220, the driver 120 resets the deviation position, and transmits the print command to the printer 130. Similarly, once the printer 130 receives the print command, the printer 130 prints the file according to the deviation position and the print command. In step S222, it is determined whether the current output page is fully printed. If not (“No” in step S222), the procedure returns to step S218, and steps S218 to S222 are repeated. If so (“Yes” in step S222), in step S224, the driver 120 transmits a page change command to the printer 130. Once the printer 130 receives the page change command, the printer 130 changes the page and loads another output medium for subsequent printing. Thereafter, the procedure returns to step 218, and steps S218 to S222 are repeated.

As described, at least one file must be opened or specified before setting the setup option via the user interface 300. If the copy number does not exceed zero (“No” in step S218), in step S226, it is determined whether the last file has been handled and printed. If not (“No” in step S226), the procedure returns to step S208, and steps S208 to S226 are repeated. If so (“Yes” in step S226), in step S228, the temporary document is deleted, the print process is complete.

It is understood that the setup option also comprises the border option. If the border option is selected, in steps S214 and S220, the driver 120 also transmits a border print command to the printer 130 for printing a border on the file.

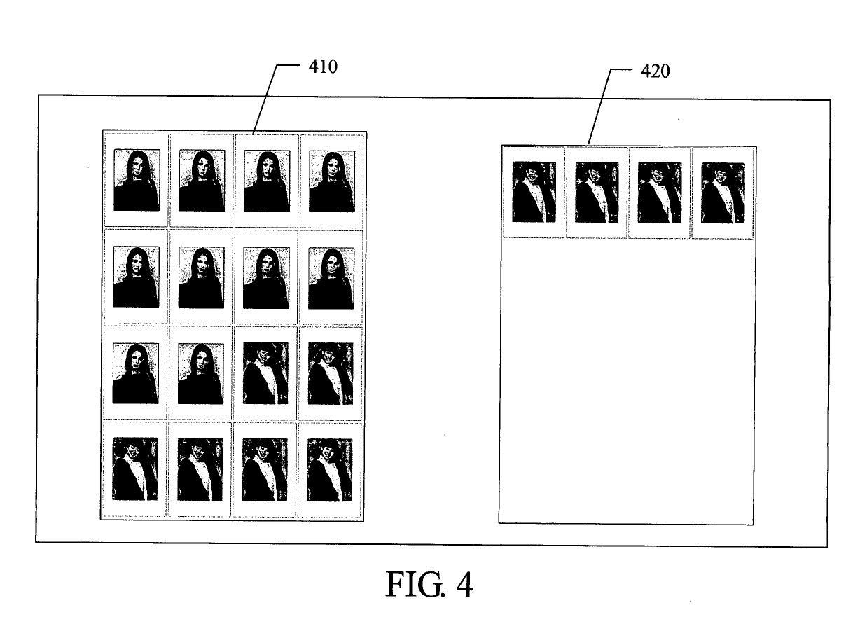

An example is disclosed. In this example, two files are specified, and the setup option is shown in FIG. 3A, where the row number is 4, the column number is 4, the border option is selected, and the copy number is 10. The output pages are shown in FIG. 4. As shown in FIG. 4, the maximum number files that can be repeatedly printed on a page is 16, and the copies of each specified file are 10. When the copies of the first file are completely printed, the second file is printed subsequent to the last copy of the first file, and the second file is repeatedly printed according to the same setup option. It is understood that after the 16th copy of the file is printed on the first page 410, the driver transmits a page change command to the printer, and loads a second page 420 for subsequent printing. It is understood that since the border option is selected, borders are printed on the files in the output pages.

Print systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A print system for repeatedly printing a file on an output medium, comprising:
a user interface receiving a setup option comprising a column number, a row number and a copy number;
a driver receiving the setup option, calculating a reduction/magnification ratio according to the column number and the row number, calculating a deviation position for each file to be repeatedly printed on the output medium according to the reduction/magnification ratio, and transmitting at least one print command corresponding to the file having the properties of the reduction/magnification ratio and the deviation position; and
a printer receiving the print command, and repeatedly printing the file on the output medium according to the print command.

2. The system of claim 1 wherein the setup option further comprises a border option, and the driver further transmits a border print command to the printer for printing a border on each printed file on the output medium.

3. The system of claim 1 wherein the driver further determines whether the number of copies of the file repeatedly printed on the output medium equal a maximum number determined by the row number and the column number, and is less than the copy number in the setup option, if so, transmits a page change command to the printer, and the printer prints the file on another output medium according to the print command.

4. The system of claim 3 wherein the driver further creates a temporary document storing the print command corresponding to the file, and the print command is read from the temporary document when the file is repeatedly printed.

5. The system of claim 4 wherein the driver further deletes the temporary document if the copy number of the file is completely printed.

6. The system of claim 1 wherein the driver further prints a second file subsequent to the last copy of the file if the copy number of the file is completely printed, and the second file is repeatedly printed according to the setup option.

7. A print method for repeatedly printing a file on an output medium, comprising:
receiving a setup option comprising a column number, a row number and a copy number;
a driver calculating a reduction/magnification ratio according to the column number and the row number;
the driver calculating a deviation position for each file to be repeatedly printed on the output medium according to the reduction/magnification ratio;
the driver transmitting at least one print command corresponding to the file having the properties of the reduction/magnification ratio and the deviation position; and
a printer receiving the print command, and repeatedly printing the file on the output medium according to the print command.

8. The method of claim 7 wherein the setup option further comprises a border option, and the method further comprises the driver transmitting a border print command to the printer for printing a border on each printed file on the output medium.

9. The method of claim 7 further comprising:
the driver determining whether the number of copies of the file repeatedly printed on the output medium equal a maximum number determined by the row number and the column number, and is less than the copy number in the setup option;
if so, the driver transmitting a page change command to the printer; and
once the page change command is received, the printer printing the file on another output medium according to the print command.

10. The method of claim 9 further comprising the driver creating a temporary document storing the print command corresponding to the file, in which the print command is read from the temporary document when the file is repeatedly printed.

11. The method of claim 10 further comprising the driver deleting the temporary document if the copy number of the file is completely printed.

12. The method of claim 7 further comprising the driver printing a second file subsequent to the last copy of the file if the copy number of the file is completely printed, and repeatedly printing the second file according to the setup option.

13. A machine-readable storage medium comprising a computer program, which, when executed, causes a device to perform a print method for repeatedly printing a file on an output medium, the method comprising:
receiving a setup option comprising a column number, a row number and a copy number;
a driver calculating a reduction/magnification ratio according to the column number and the row number;
the driver calculating a deviation position for each file to be repeatedly printed on the output medium according to the reduction/magnification ratio;
the driver transmitting at least one print command corresponding to the file having the properties of the reduction/magnification ratio and the deviation position; and
a printer receiving the print command, and repeatedly printing the file on the output medium according to the print command.

14. A print method for repeatedly printing a file on an output medium, comprising:
(a) receiving a setup option comprising a column number, a row number and a copy number;
(b) a driver calculating a reduction/magnification ratio according to the column number and the row number;
(c) the driver generating a print command corresponding to the file according to the reduction/magnification ratio;
(d) the driver calculating and setting a deviation position for the file to be printed on the output medium;
(e) a printer printing the file on the output medium according to the deviation position and the print command;
(f) reducing the copy number in the setup option by 1; and
(g) repeating steps (d) to (f) until the copy number equals 0.
